(19) United States
(12) Patent Application Publication
(10) Pub. No.: US 2023/0117123 A1
(43) Pub. Date: Apr. 20, 2023

(54) HEAT AND OIL RESISTANT COMPOSITIONS

(71) Applicant: Dow Global Technologies LLC, Midland, MI (US)

(72) Inventors: Krischan Jeltsch, Zuerich (CH); Bernard Cora, Haguenau (FR)

(21) Appl. No.: 17/913,559

(22) PCT Filed: Jun. 23, 2021
(86) PCT No.: PCT/US2021/038579

§ 371 Date: Sep. 22, 2022

Related U.S. Application Data
(60) Provisional application No. 63/047,013, filed on Jul. 1, 2020.

(51) Int. Cl. C08L 23/08; C08L 51/00

(52) U.S. Cl. CPC C08L 23/0846; C08L 51/003; C08L 2203/20; C08L 2207/53; C08L 2666/84

(57) ABSTRACT

A resin composition includes 20 wt % to 70 wt % of an ethylene polymer based on a total weight of the resin composition, wherein the ethylene polymer comprises a polar comonomer; and 30 wt % to 80 wt % of an acrylate phase based on the total weight of the resin composition, wherein the acrylate phase comprises units derived from butyl acrylate and units derived from methyl methacrylate.

### BACKGROUND

### Field of the Disclosure

The present disclosure relates to compositions, and more specifically, to resin and polymeric compositions that exhibit heat and oil resistance.

### INTRODUCTION

Wires and cables utilized in locations such as offshore oil platforms, nuclear power plants, windmills, high speed trains, and different industrial settings are subjected to extreme environments. In order to prolong the life and usefulness of the wires and cables, heavy duty jacketing that provides both oil and heat resistance is needed. Flexibility under ambient and low temperature conditions is a necessary property of the jacketing though as such wires and cables need to be installed. Validation of the heat and oil resistance properties of the jacketing are performed under accelerated oil testing and accelerated heat testing. Passage of the accelerated testing generally requires that the post-accelerated testing tensile strength (Ts) value and elongation percent (E) value be, depending on the applicable standard, in the range of within ±30% of pre-accelerated testing values in order to pass. Achieving a balance of low temperature flexibility, oil resistance, heat resistance and manufacturability is difficult to accomplish.

A variety of jacketing compounds exist to address heat resistance and oil resistance. For example, high performance compounds that offer flexibility, oil resistance, and heat resistance often utilize copolymers having a high acrylate content. In addition to such high-performance compounds often being cost prohibitive, the compounds face manufacturing difficulties from the compound's form factor of sticky bales rather than pellets. Low performance compounds that offer mild oil and/or heat resistance are also available. Low performance compounds are typically based on copolymers having moderate levels of vinyl acetate (i.e., <40%) and have a lower price and may be pelletized, but such are typically brittle at low temperatures and only exhibit mild oil resistance.

Attempts at creating well performing compounds have been made. One successful example is detailed in U.S. Pat. No. 8,779,061 (“'061 patent”). The '061 patent provides a compound utilizing a terpolymer of ethylene, vinyl acetate or alkyl(meth)acrylate, and carbon monoxide in order to provide its properties. The compounds of the '061 patent are believed to be flexible and capable of being be pelletized due to the addition of the terpolymer with the polar carbon monoxide providing superior oil resistance. However, the use of the carbon monoxide monomer is believed to negatively impact the heat resistance properties of the compound.

Given the tradeoff in properties demonstrated by the available compounds and the necessity of the carbon monoxide monomer to achieve a balanced solution, it would be surprising to discover a polymeric composition that can be pelletized, is free of carbon monoxide monomer and exhibits post-accelerated testing Ts and E values within ±30% of pre-accelerated testing Ts and E values.

### SUMMARY OF THE DISCLOSURE

The present invention provides a polymeric composition that can be pelletized, is free of carbon monoxide monomer and exhibits post-accelerated testing Ts and E values within ±30% of pre-accelerated testing Ts and E values.

The inventors of the present application have surprisingly discovered that the use of an acrylate phase comprising units derived from butyl acrylate and units derived from methyl methacrylate allows for the formation of resin compositions that retain Ts and E values within ±30% after accelerated heat and oil testing. The acrylate phase may exist as a plurality of particles having a core-shell morphology with the units derived from butyl acrylate forming the core and the units derived from butyl acrylate methyl methacrylate forming the shell around the core. When mixed and blended with an ethylene polymer comprising a polar comonomer, the core-shell morphology is believed to persist allowing shell of methyl methacrylate the function as a compatibilizer between the core and the ethylene polymer. The resin composition is able to be pelletized, is free of carbon monoxide monomer. The resin composition may then be blended with a flame-retardant filler to form a polymeric composition. The polymeric composition exhibits post-accelerated testing Ts and E values within ±30% of pre-accelerated testing Ts and E values. Additionally, the compositions of the present disclosure surprisingly and advantageously exhibit greater Ts values that conventional compositions.

The resin and polymeric compositions of the present disclosure are particularly useful for the formation of coated conductors.

According to a first feature of the present disclosure, a resin composition comprises 20 wt % to 70 wt % of an ethylene polymer based on a total weight of the resin composition, wherein the ethylene polymer comprises a polar comonomer; and 30 wt % to 80 wt % of an acrylate phase based on the total weight of the resin composition, wherein the acrylate phase comprises units derived from butyl acrylate and units derived from methyl methacrylate.

According to a second feature of the present disclosure, the resin composition comprises 50 wt % to 80 wt % of the acrylate phase based on a total weight of the resin composition.

According to a third feature of the present disclosure, the resin composition comprises 20 wt % to 50 wt % of the ethylene polymer based on a total weight of the resin composition.

According to a fourth feature of the present disclosure, the ethylene polymer comprises a polar comonomer content of 40 wt % or less based on a total weight of the ethylene polymer.

According to a fifth feature of the present disclosure, the ethylene polymer comprises ethylene vinyl acetate, ethylene methyl acrylate copolymer, ethylene butyl acrylate copolymer, ethylene ethyl acrylate copolymer.

According to a sixth feature of the present disclosure, the acrylate phase comprises a core-shell morphology where a portion of the shell is in contact with and surrounding a portion the core, and further wherein the shell comprises the units derived from methyl methacrylate and the core comprises the units derived from butyl acrylate.

According to a seventh feature of the present disclosure, the core is crosslinked.

According to an eighth feature of the present disclosure, a polymeric composition, comprises 20 wt % to 50 wt % of the resin composition based on a total weight of the polymeric composition; and 40 wt % to 75 wt % of a flame-retardant filler based on a total weight of the polymeric composition, wherein the flame-retardant filler comprises at least one of magnesium hydroxide, aluminum trihydrate, calcium carbonate, hydrated calcium silicate and hydrated magnesium.

According to a ninth feature of the present disclosure, the ethylene polymer of the resin composition comprises a hydrolyzable silane monomer of the formula:

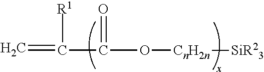

in which R¹ is a hydrogen atom or methyl group; x is 0 or 1; n is an integer from 1 to 4, or 6, or 8, or 10, or 12; and each R² independently is a hydrolyzable organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl.

According to a tenth feature of the present disclosure, a coated conductor comprises a conductor; and the polymeric composition disposed at least partially around the conductor.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise indicated. The term mole percent (“mol %”) designates the percentage by moles a component is of a total moles of the item in which the component is present.

Unless otherwise provided herein, density is measured in accordance with ASTM D792, Method B. The result is recorded in grams (g) per cubic centimeter (g/cc).

Unless otherwise provided herein, a melt index (MI) is measured in accordance with ASTM D1238, Condition 190° C./2.16 kilogram (kg) weight and is reported in grams eluted per 10 minutes (g/10 min).

“Polymer” means a polymeric compound prepared by polymerizing monomers, whether of the same or a different type. The generic term polymer thus embraces the terms homopolymer, interpolymer and copolymer.

“Ethylene polymer” means a polymer containing units derived from ethylene. Ethylene polymers typically comprises at least 50 mol % units derived from ethylene. Polyethylene is an ethylene polymer.

### Resin and Polymeric Compositions

The present disclosure provides a resin composition and a polymeric composition. The resin composition may be utilized on its own or may be used to form the polymeric composition. The resin composition comprises an ethylene polymer comprising a polar comonomer. The resin composition also comprises an acrylate phase. The resin composition may be a dry mix of the components or may be a melt blended mix of the components. The resin composition can be combined with a flame-retardant filler to form the polymeric composition. The polymeric composition may comprise one or more additives and/or crosslinking agents. As will be explained in greater detail below, the resin composition and/or the polymeric composition may be utilized to form a jacket of a coated conductor. The resin composition and the polymeric composition are both capable of being pelletized. The polymeric composition may be used as thermoplastic or crosslinked via peroxides, electron beam or silane enabled moisture cure mechanisms.

### Ethylene Polymer

The resin composition comprises an ethylene polymer. The ethylene polymer may comprise 50 mol % or greater, 60 mol % or greater, 70 mol % or greater, 80 mol % or greater, 85 mol % or greater, 90 mol % or greater, or 91 mol % or greater, or 92 mol % or greater, or 93 mol % or greater, or 94 mol % or greater, or 95 mol % or greater, or 96 mol % or greater, or 97 mol % or greater, or 97.5 mol % or greater, or 98 mol % or greater, or 99 mol % or greater, while at the same time, 100 mol % or less, 99.5 mol % or less, or 99 mol % or less, or 98 mol % or less, or 97 mol % or less, or 96 mol % or less, or 95 mol % or less, or 94(mol % or less, or 93 mol % or less, or 92 mol % or less, or 91 mol % or less, or 90 mol % or less, or 85 mol % or less, or 80 mol % or less, or 70 mol % or less, or 60 mol % or less of ethylene as measured using Nuclear Magnetic Resonance (NMR) or Fourier-Transform Infrared (FTIR) Spectroscopy. Other units of the ethylene polymer may include C₃ to C₄, or C₆, or C₈, or C₁₀, or C₁₂, or C₁₆, or C₁₈, or C₂₀ α-olefins, such as propylene, 1-butene, 1-hexene, 4-methyl-1-pentene, and 1-octene. Other units of the ethylene polymer may be derived from one or more polymerizable monomers including, but not limited to, polar monomers such as unsaturated esters. The unsaturated esters (i.e. polar monomers) may be alkyl acrylates, alkyl methacrylates, or vinyl carboxylates. The alkyl groups can have from 1 to 8 carbon atoms, or from 1 to 4 carbon atoms. The carboxylate groups can have from 2 to 8 carbon atoms, or from 2 to 5 carbon atoms. Examples of acrylates and methacrylates include, but are not limited to, ethyl acrylate, methyl acrylate, methyl methacrylate, t-butyl acrylate, n-butyl acrylate, n-butyl methacrylate, and 2 ethylhexyl acrylate. Examples of vinyl carboxylates include, but are not limited to, vinyl acetate, vinyl propionate, and vinyl butanoate. The ethylene polymer may have a polar comonomer content of 40 wt % or less, or 35 wt % or less, or 30 wt % or less, or 25 wt % or less, or 20 wt % or less, 15 wt %, or 10 wt %, or 5 wt % or less, or 3 wt % or less, or 1 wt % or less, or 0 wt % based on the total weight of the ethylene polymer as measured using Nuclear Magnetic Resonance (NMR) or Fourier-Transform Infrared (FTIR) Spectroscopy.

The ethylene polymer may be an ultra-low-density polyethylene or a linear low-density polyethylene or a high-density polyethylene or an ethylene ethyl acrylate copolymer or an ethylene vinyl acetate copolymer. The density of the ethylene polymer may be 0.860 g/cc or greater, 0.870 g/cc or greater, or 0.880 g/cc or greater, or 0.890 g/cc or greater, or 0.900 g/cc or greater, or 0.904 g/cc or greater, or 0.910 g/cc or greater, or 0.915 g/cc or greater, or 0.920 g/cc or greater, or 0.921 g/cc or greater, or 0.922 g/cc or greater, or 0.925 g/cc to 0.930 g/cc or greater, or 0.935 g/cc or greater, while at the same time, 0.990 g/cc or less, 0.980 g/cc or less, 0.970 g/cc or less, 0.967 g/cc or less, or 0.960 g/cc or less, or 0.950 g/cc or less, or 0.940 g/cc or less, or 0.935 g/cc or less, or 0.930 g/cc or less, or 0.925 g/cc or less, or 0.920 g/cc or less, or 0.915 g/cc or less, or 0.910 g/cc or less, or 0.905 g/cc or less, or 0.900 g/cc or less as measured by ASTM D792.

The melt index of the ethylene polymer may be 0.5 g/10 min or greater, or 1.0 g/10 min or greater, or 1.5 g/10 min or greater, or 2.0 g/10 min or greater, or 2.5 g/10 min or greater, or 3.0 g/10 min or greater, or 3.5 g/10 min or greater, or 4.0 g/10 min or greater, or 4.5 g/10 min or greater, or 10.0 g/10 min or greater, or 18 g/10 min or greater, while at the same time, 30.0 g/10 min or less, or 25.0 g/10 min or less, or 20.0 g/10 min or less, or 18.0 g/10 min or less, or 15.0 g/10 min or less, or 10.0 g/10 min or less, or 5.0 g/10 min or less, or 4.5 g/10 min or less, or 4.0 g/10 min or less, or 3.5 g/10 min or less, or 3.0 g/10 min or less, or 2.5 g/10 min or less, or 2.0 g/10 min or less, or 1.5 g/10 min or less, or 1.0 g/10 min or less as measured according to ASTM D1238.

The resin composition comprises from 20 wt % to 70 wt % of the ethylene polymer. For example, the resin composition may comprise 20 wt % or greater, or 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, while at the same time, 70 wt % or less, or 65 wt % or less, or 60 wt % or less, or 55 wt % or less, or 50 wt % or less, or 45 wt % or less, or 40 wt % or less, or 35 wt % or less, or 30 wt % or less, or 25 wt % or less of the ethylene polymer based on the total weight of the resin composition.

The ethylene polymer may comprise ethylene vinyl acetate, ethylene methyl acrylate copolymer, ethylene butyl acrylate copolymer, ethylene ethyl acrylate copolymer. A specific example of an ethylene polymer useful in this invention includes ELVAX™ polymers available from The Dow Chemical Company, Midland, Mich.

### Acrylate Phase

The resin composition comprises the acrylate phase. The acrylate phase comprises butyl acrylate polymer and polymethyl methacrylate polymer. During formation of the resin composition, the acrylate phase is added to the ethylene polymer as a plurality of particles having a core-shell morphology. As defined herein, a core-shell morphology means that the particles exhibit a layered structure where a central core having a first distinct composition or physical characteristic (e.g., crosslinking, molecular weight, polydispersity index, melt flow index, etc.) is partially, substantially, or completely surrounded or enveloped by, and in contact with, one or more layers having a separate composition and/or physical characteristic. The acrylate phase may comprise a core and a shell. In some examples, the acrylate phase may comprise a core, an intermediate layer and a shell. In examples where the acrylate phase is melt blended with other components to form the resin composition and/or the polymeric composition, it is believed the core-shell morphology generally remains intact, but that the shell may fuse/bond with the other components of the composition to form a single contiguous melt. It will be understood that optional intermediate layers and the core will generally remain intact. Such a feature may be advantageous in allowing features of the different components of the acrylate phase (e.g., resiliency of the core) to remain and be imparted to the composition while achieving a contiguous composition (e.g., compatibilization of the core with the ethylene polymer and/or the flame retardant filler through fusing of the outer layers together).

The average particle size of the acrylate phase may range from 30 nanometers (nm) to 250 nm. For example, the average particle size may be 30 nm or greater, or 50 nm or greater, or 70 nm or greater, or 90 nm or greater, or 110 nm or greater, or 130 nm or greater, or 150 nm or greater, or 170 nm or greater, or 190 nm or greater, or 210 nm or greater, or 230 nm or greater or 240 nm or greater, while at the same time, 250 nm or less, or 240 nm or less, or 230 nm or less, or 220 nm or less, or 210 nm or less, or 200 nm or less, or 190 nm or less, or 170 nm or less, or 150 nm or less, or 130 nm or less, or 110 nm or less, or 90 nm or less, or 70 nm or less, or 50 nm or less. “Average particle size,” as used herein means weight average particle size of the emulsion (co)polymer particles as measured using a Brookhaven BI-90 Particle Sizer.

The resin composition comprises from 30 wt % to 80 wt % of the acrylate phase. For example, the resin composition may comprise 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, while at the same time, 80 wt % or less, or 75 wt % or less, or 70 wt % or less, or 65 wt % or less, or 60 wt % or less, or 55 wt % or less, or 50 wt % or less, or 45 wt % or less, or 40 wt % or less, or 35 wt % or less of the acrylate phase based on the total weight of the resin composition.

The acrylate phase may be manufactured as described in U.S. Pat. Nos. 10,040,915, 8,420,736 and 8,362,147. The acrylate phase is formed of the core, one or more optional intermediate layers, and a shell. As described below, each of the core, one or more optional intermediate layers, and shell may be formed of a variety of materials. It will be understood that the acrylate phase may comprise two or more different combinations of the materials forming the core, intermediate layer and/or shell. In other words, the particles of different compositions may be used to form the acrylate phase.

### Core

The core comprises units derived from one or more monomers selected from the group consisting of alkyl(meth)acrylate monomers. The core may comprise 95 wt % or greater, or 95.5 wt % or greater, or 96 wt % or greater, or 96.5 wt % or greater, or 97 wt % or greater, or 97.5 wt % or greater, or 98 wt % or greater, or 98.5 wt % or greater, or 99 wt % or greater, or 99.5 wt % while at the same time, 100 wt % or less, or 99.5 wt % or less, or 99.0 wt % or less or 98.5 wt % or less or 98.0 wt % or less or 97.5 wt % or less or 97.0 wt % or less or 96.5 wt % or less, or 96.0 wt % or less, or 95.5 wt % or less of units derived from one or more monomers selected from the group consisting of alkyl(meth)acrylate monomers.

The alkyl(meth)acrylate monomers useful in the core include linear and branched alkyl(meth)acrylates wherein the alkyl group has from 1 to 12 carbon atoms. Exemplary useful monomers for forming the core include butyl acrylate, ethyl hexyl acrylate, ethyl acrylate, methyl methacrylate, butyl methacrylate, and iso-octylacrylate and combinations of two or more thereof.

The core may be crosslinked. In crosslinked examples, the core comprises from 0.1 wt % to 5 wt % of units derived from a cross-linking monomer, graft-linking monomer, or combination thereof. The amount of units derived from cross-linking monomer, graft-linking monomer, or combination thereof can be 0.1 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, while at the same time, 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less of units derived from cross-linking monomer, graft-linking monomer.

Cross-linking and/or graft-linking monomers useful in the crosslinked core include butanediol di(meth)acrylate, ethylene glycol di(meth)acrylate, divinyl benzene, butanediol diacrylate, diethylene glycol di(meth)acrylate, diallyl maleate, allyl methacrylate, diallyl phthalate, triallyl phthalate, trimethylolpropane tri(meth)acrylate, allyl methacrylate, blends thereof and combinations of two or more thereof.

The core has a glass transition temperature (Tg) of from −85° C. to −10° C. For example, the Tg of the core can be from −85° C. or greater, or −70° C. or greater, or −60° C. or greater, or −50° C. or greater, or −40° C. or greater, or −30° C. or greater, or −20° C. or greater, or −10° C. or greater, while at the same time, −10° C. or less, or −20° C. or less, or −30° C. or less, or −40° C. or less, or −50° C. or less, or −60° C. or less, or −70° C. or less as measured according to ASTM D3418.

### Intermediate Layers

The acrylate phase may comprise one or more optional intermediate layers. The acrylate phase may one, two, three, four, or five intermediate layers. Each of the intermediate layers comprises units derived from a one or more monomers selected from the group consisting of alkyl(meth)acrylate monomers. The alkyl(meth)acrylate monomers useful in the intermediate layers include linear and branched alkyl(meth)acrylates wherein the alkyl group has from 1 to 12 carbon atoms. Exemplary useful monomers include butyl acrylate, ethyl hexyl acrylate, ethyl acrylate, methyl methacrylate, butyl methacrylate, cyclohexyl methacrylate, cyclopentyl acrylate, benzyl acrylate, benzyl methacrylate, iso-octylacrylate, styrene, α-methylstyrene, vinyl toluene and combinations of two or more thereof.

Each intermediate layer may comprise 88.5 wt % or greater, or 89.0 wt % or greater, or 89.5 wt % or greater, or 90.0 wt % or greater, or 90.5 wt % or greater, or 91.0 wt % or greater, or 91.5 wt % or greater, or 92.0 wt % or greater, or 92.5 wt % or greater, or 93.0 wt % or greater, or 93.5 wt % or greater, or 94.0 wt % or greater, or 94.5 wt % or greater, 95.0 wt % or greater, or 95.5 wt % or greater, or 96.0 wt % or greater, or 96.5 wt % or greater, or 97.0 wt % or greater, or 97.5 wt % or greater, or 98.0 wt % or greater, or 98.5 wt % or greater, or 99.0 wt % or greater, or 99.5 wt % while at the same time, 100 wt % or less, or 99.5 wt % or less, or 99.0 wt % or less, or 98.5 wt % or less, or 98.0 wt % or less, or 97.5 wt % or less, or 97.0 wt % or less, or 96.5 wt % or less, or 96.0 wt % or less, or 95.5 wt % or less, or 94.5 wt % or less, or 94.0 wt % or less, or 93.5 wt % or less, or 93.0 wt % or less, or 92.5 wt % or less, or 92.0 wt % or less, or 91.5 wt % or less, or 91.0 wt % or less, or 90.5 wt % or less, or 90.0 wt % or less, or 89.5 wt % or less, or 89.0 wt % or less, of units derived from one or more monomers selected from the group consisting of alkyl(meth)acrylate monomers.

One of the intermediate layers may be crosslinked. In crosslinked examples, each of the intermediate layers may comprise from 0.1 wt % to 5 wt % of units derived from a cross-linking monomer, graft-linking monomer, or combination thereof. The amount of units derived from cross-linking monomer, graft-linking monomer, or combination thereof can be 0.1 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, while at the same time, 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less of units derived from cross-linking monomer, graft-linking monomer.

Cross-linking and/or graft-linking monomers useful in the intermediate layers include, for example, butanediol di(meth)acrylate, ethylene glycol di(meth)acrylate, divinyl benzene, butanediol diacrylate, diethylene glycol di(meth)acrylate, diallyl maleate, allyl methacrylate, diallyl phthalate, triallyl phthalate, trimethylolpropane tri(meth)acrylate, allyl methacrylate, blends thereof and combinations of two or more thereof.

### Shell

The shell is the outermost layer of the acrylate phase when in particle form. The shell may comprise 98 wt % or greater, or 98.5 wt % or greater, or 99 wt % or greater, or 99.5 wt % or greater, while at the same time, 100 wt % or less, or 99.5 wt % or less, or 99.0 wt % or less or 98.5 wt % or less of units derived from one or more monomers selected from the group consisting of alkyl(meth)acrylate monomers. The alkyl(meth)acrylate monomers useful in the shell include linear and branched alkyl(meth)acrylates wherein the alkyl group has from 1 to 12 carbon atoms. Exemplary useful monomers include butyl acrylate, ethyl hexyl acrylate, ethyl acrylate, methyl methacrylate, butyl methacrylate, vinyl toluene, and combinations of two or more thereof. The shell may also comprise one or more styrenic monomers including styrene and α-methylstyrene.

In view of the foregoing, the acrylate phase may comprise from 80 wt % to 94 wt % of units derived from butyl acrylate and from 6 wt % to 20 wt % of units derived from methyl methacrylate.

### Polymeric Composition

The polymeric composition is comprised of the resin composition, a flame-retardant filler and optionally one or more additives. The polymeric composition may comprise from 20 wt % to 50 wt % of the resin composition. For example, the resin composition may comprise 20 wt % or greater, or 25 wt % or greater, or 30 wt % or greater, or 35 wt % or greater, or 40 wt % or greater, or 45 wt % or greater, while at the same time, 50 wt % or less, or 45 wt % or less, or 40 wt % or less, or 35 wt % or less, or 30 wt % or less, or 25 wt % or less of the resin composition based on the total weight of the polymeric composition. It will be understood that to determine the acrylate phase or ethylene polymer concentration within the polymeric composition, the weight percent of the target component is multiplied by the weight percent of the resin composition within the polymeric composition.

### Flame-Retardant Filler

The flame-retardant filler can inhibit, suppress, or delay the production of flames. In some examples, the flame-retardant filler may be halogen-free. As used herein, “halogen-free” and like terms indicate that the flame-retardant filler is without or substantially without halogen content, i.e., contain less than 10,000 mg/kg of halogen as measured by ion chromatography (IC) or a similar analytical method. Halogen content of less than this amount is considered inconsequential to the efficacy of the flame-retardant filler as, for example, in a coated conductor.

Examples of the flame-retardant fillers suitable for use in the polymeric composition include, but are not limited to, halogenated materials, metal hydroxides, red phosphorous, ammonium polyphosphate, silica, alumina, titanium oxide, carbon nanotubes, talc, clay, organo-modified clay, calcium carbonate, zinc oxide, zinc molybdate, zinc sulfide, zinc borate, antimony trioxide, wollastonite, mica, ammonium octamolybdate, frits, hollow glass microspheres, intumescent compounds, expanded graphite, and combinations thereof. Halogen free examples of the flame-retardant filler may comprise at least one of magnesium hydroxide, aluminum trihydrate, calcium carbonate, hydrated calcium silicate, aluminum hydroxide and hydrated magnesium. Commercially available examples of flame-retardant fillers suitable for use in the polymeric composition include, but are not limited to, APYRAL™ 40CD available from Nabaltec AG, Schwandorf, Germany and FR-20-100 from Israel Chemicals Ltd. of Tel Aviv-Yafo, Israel.

The flame-retardant filler can optionally be surface treated (coated). The surface treatment may be done with a saturated or unsaturated carboxylic acid having 8 to 24 carbon atoms, or 12 to 18 carbon atoms, or a metal salt of the acid. Alternatively, the acid or salt can be merely added to the polymeric composition in like amounts rather than using the surface treatment procedure. Other surface treatments may include silanes, titanates, phosphates and zirconates may also be utilized. Other surface treatments not disclosed here may also be used.

The polymeric composition may comprise the flame-retardant filler in an amount from 40 wt % to 75 wt % based on a total weight of the polymeric composition. For example, the polymeric composition may comprise 40 wt % or greater, or 45 wt % or greater, or 50 wt % or greater, or 55 wt % or greater, or 60 wt % or greater, or 65 wt % or greater, or 70 wt % or greater, while at the same time, or 75 wt % or less, or 70 wt % or less, or 65 wt % or less, or 60 wt % or less or 55 wt % or less, or 50 wt % or less of the flame-retardant filler based on the total weight of the polymeric composition.

### Hydrolysable Silane Monomer

The polymeric composition may include a hydrolysable silane monomer used to cross link the ethylene polymer A “hydrolysable silane monomer” is grafted to the ethylene polymer to produce a silane-grafted ethylene polymer. Any hydrolysable silane or a mixture of such hydrolysable silanes that will effectively graft to the ethylene polymer (and thus enable subsequent crosslinking of the silane-grafted ethylene polymer) can be used. A representative, but not limiting, example of a hydrolysable silane monomer has structure (I):

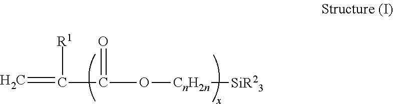

in which R¹ is a hydrogen atom or methyl group; x is 0 or 1; n is an integer from 1 to 4, or 6, or 8, or 10, or 12; and each R² independently is a hydrolyzable organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl.

The hydrolysable silane monomer may include silane monomers that comprise an ethylenically unsaturated hydrocarbyl group, such as a vinyl, allyl, isopropenyl, butenyl, cyclohexenyl or gamma (meth)acryloxy allyl group, and a hydrolyzable group, such as, for example, a hydrocarbyloxy, hydrocarbonyloxy, or hydrocarbylamino group. Hydrolyzable groups may include methoxy, ethoxy, formyloxy, acetoxy, proprionyloxy, and alkyl or arylamino groups. In a specific example, the hydrolyzable silane monomer is an unsaturated alkoxy silane, which can be grafted onto the ethylene polymer. Examples of hydrolysable silane monomers include vinyltrimethoxysilane (VTMS), vinyltriethoxysilane (VTES), vinyltriacetoxysilane, and gamma-(meth)acryloxy propyl trimethoxy silane. In context to Structure (I), for VTMS: x=0; R¹=hydrogen; and R²=methoxy; for VTES: x=0; R¹=hydrogen; and R²=ethoxy; and for vinyltriacetoxysilane: x=0; R¹=H; and R²=acetoxy.

### Free Radical Initiator

In examples where the polymeric composition comprises the hydrolysable silane monomer, the polymeric composition may comprise a free radical initiator. The hydrolysable silane monomer is grafted to the ethylene polymer through the use of a free radical initiator. Examples of free radical initiators include a peroxide, an azo compound (i.e., compounds bearing a diazinyl moiety), and/or by ionizing radiation. The free radical initiator may be an organic peroxide such as dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, and t-butyl peracetate. An example of an azo compound is azobisisobutyronitrile.

The amount of initiator used may be 0.04 wt % or greater or 0.06 wt % or greater, while at the same time, 1.00 wt % or less, or 0.50 wt % or less, or 0.30 wt % or less, or 0.15 wt % or less or 0.10 wt % or less based on a total weight of the combined ethylene polymer, hydrolysable silane monomer and initiator. The weight ratio of hydrolysable silane monomer to initiator may be from 5:1 to 70:1 or from 10:1 to 30:1. With certain polymers with unsaturation it may be possible to graft without any initiator at all using radicals generated by heat and shear.

### Silane Grafting of the Ethylene Polymer

Typically, the ethylene polymer is grafted with the hydrolysable silane monomer prior to mixing the ethylene polymer with the flame-retardant filler. Alternatively, an in-situ Si-g-PE is formed by a process such as the MONOSIL process, in which a hydrolysable silane monomer is grafted onto the backbone of an ethylene polymer during the extrusion of the polymeric composition to form a coated conductor, as described, for example, in U.S. Pat. No. 4,574,133. The ethylene polymer, hydrolysable silane monomer and free radical initiator are mixed using known equipment and techniques and subjected to a grafting temperature of from 120° C. to 270° C. Typically, the mixing equipment is either a BANBURY™ mixer or similar mixer, or a single or twin-screw extruder. Other extruders like counter-rotating twin screw extruders, kneaders, planetary extruders, multi-screw extruders may also be used. A combination of two or more of the above-mentioned mixers or extruders in tandem may also be used.

### Maleated Ethylene Polymer

The ethylene polymer may be maleated. The polymeric composition may include both the maleated ethylene polymer and/or the silane-grafted ethylene polymer. As used herein, the term “maleated” indicates an ethylene polymer that has been modified to incorporate a maleic anhydride monomer. Maleated ethylene polymer can be formed by copolymerization of maleic anhydride monomer with ethylene and other monomers (if present) to prepare an interpolymer having maleic anhydride incorporated into the polymer backbone. Additionally, or alternatively, the maleic anhydride can be graft-polymerized to the ethylene polymer. The ethylene polymer that is maleated may be any of the previously discussed polyolefin elastomers.

The maleated ethylene polymer can have a maleic anhydride content, based on the total weight of the maleated ethylene polymer, of 0.25 wt % or greater, or 0.50 wt % or greater, or 0.75 wt % or greater, or 1.00 wt % or greater, or 1.25 wt % or greater, or 1.50 wt % or greater, or 1.75 wt % or greater, or 2.00 wt % or greater, or 2.25 wt % or greater, or 2.50 wt % or greater, or 2.75 wt % or greater, while at the same time, 3.00 wt % or less, 2.75 wt % or less, or 2.50 wt % or less, or 2.25 wt % or less, or 2.00 wt % or less, or 1.75 wt % or less, or 1.50 wt % or less, or 1.25 wt % or less, or 1.00 wt % or less, or 0.75 wt % or less, or 0.5 wt % or less. Maleic anhydride concentrations are determined by Titration Analysis. Titration Analysis is performed by utilizing dried resin and titrates with 0.02N KOH to determine the amount of maleic anhydride. The dried polymers are titrated by dissolving 0.3 to 0.5 grams of maleated polymer in about 150 mL of refluxing xylene. Upon complete dissolution, deionized water (four drops) is added to the solution and the solution is refluxed for 1 hour. Next, 1% thymol blue (a few drops) is added to the solution and the solution is over titrated with 0.02N KOH in ethanol as indicated by the formation of a purple color. The solution is then back-titrated to a yellow endpoint with 0.05N HCl in isopropanol.

An example of a suitable class of commercially available maleated ethylene polymers is sold under the trade name FUSABOND™ and is available from The Dow Chemical Company, Midland, Mich., USA.

### Additives

The polymeric composition may include one or more additives. Nonlimiting examples of suitable additives include antioxidants, colorants, corrosion inhibitors, lubricants, silanol condensation catalysts, ultraviolet (UV) absorbers or stabilizers, anti-blocking agents, flame-retardants, coupling agents, compatibilizers, plasticizers, fillers, processing aids, and combinations thereof.

The polymeric composition may include an antioxidant. Nonlimiting examples of suitable antioxidants include phenolic antioxidants, thio-based antioxidants, phosphate-based antioxidants, and hydrazine-based metal deactivators. Suitable phenolic antioxidants include high molecular weight hindered phenols, methyl-substituted phenol, phenols having substituents with primary or secondary carbonyls, and multifunctional phenols such as sulfur and phosphorous-containing phenol. Representative hindered phenols include 1,3,5-trimethyl-2,4,6-tris-(3,5-di-tert-butyl-4-hydroxybenzyl)-benzene; pentaerythrityl tetrakis-3 (3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol;6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate]. The polymeric composition may include pentaerythritol tetrakis(3-(3,5-di-tert-butyl-4-hydroxyphenyl)propionate), commercially available as Irganox™ 1010 from BASF. A nonlimiting example of a suitable methyl-substituted phenol is isobutylidenebis(4,6-dimethylphenol). A nonlimiting example of a suitable hydrazine-based metal deactivator is oxalyl bis(benzylidiene hydrazide). The polymeric composition may contain from 0 wt %, or 0.001 wt %, or 0.01 wt %, or 0.02 wt %, or 0.05 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt % antioxidant, based on total weight of the polymeric composition.

The polymeric composition may include a silanol condensation catalyst, such as Lewis and Brønsted acids and bases. A “silanol condensation catalyst” promotes crosslinking of the silane functionalized polyolefin through hydrolysis and condensation reactions. Lewis acids are chemical species that can accept an electron pair from a Lewis base. Lewis bases are chemical species that can donate an electron pair to a Lewis acid. Nonlimiting examples of suitable Lewis acids include the tin carboxylates such as dibutyl tin dilaurate (DBTDL), dimethyl hydroxy tin oleate, dioctyl tin maleate, di-n-butyl tin maleate, dibutyl tin diacetate, dibutyl tin dioctoate, stannous acetate, stannous octoate, and various other organo-metal compounds such as lead naphthenate, zinc caprylate and cobalt naphthenate. Nonlimiting examples of suitable Lewis bases include the primary, secondary and tertiary amines Nonlimiting examples of suitable Brønsted acids are methanesulfonic acid, benzenesulfonic acid, dodecylbenzenesulfonic acid, naphthalenesulfonic acid, or an alkylnaphthalenesulfonic acid. The silanol condensation catalyst may comprise a blocked sulfonic acid. The blocked sulfonic acid may be as defined in US 2016/0251535 A1 and may be a compound that generates in-situ a sulfonic acid upon heating thereof, optionally in the presence of moisture or an alcohol. Examples of blocked sulfonic acids include amine-sulfonic acid salts and sulfonic acid alkyl esters. The blocked sulfonic acid may consist of carbon atoms, hydrogen atoms, one sulfur atom, and three oxygen atoms, and optionally a nitrogen atom. These catalysts are typically used in moisture cure applications. The polymeric composition includes from 0 wt %, or 0.001 wt %, or 0.005 wt %, or 0.01 wt %, or 0.02 wt %, or 0.03 wt % to 0.05 wt %, or 0.1 wt %, or 0.2 wt %, or 0.5 wt %, or 1.0 wt %, or 3.0 wt %, or 5.0 wt % or 10 wt % silanol condensation catalyst, based on the total weight of the polymeric composition. The silanol condensation catalyst is typically added to the article manufacturing-extruder (such as during cable manufacture) so that it is present during the final melt extrusion process. As such, the silane functionalized polyolefin may experience some crosslinking before it leaves the extruder with the completion of the crosslinking after it has left the extruder, typically upon exposure to moisture (e.g., a sauna, hot water bath or a cooling bath) and/or the humidity present in the environment in which it is stored, transported or used.

The silanol condensation catalyst may be included in a catalyst masterbatch blend with the catalyst masterbatch being included in the composition. Nonlimiting examples of suitable silanol condensation catalyst masterbatches include those sold under the trade name SI-LINK™ from The Dow Chemical Company, including SI-LINK™ DFDB-5480 NT, SI-LINK™ DI-DA-5481 NT and SI-LINK™ AC DFDA-5488 NT. In an embodiment, the composition contains from 0 wt %, or 0.001 wt %, or 0.01 wt %, or 0.5 wt %, or 1.0 wt %, or 2.0 wt %, or 3.0 wt %, or 4.0 wt % to 5.0 wt %, or 6.0 wt %, or 7.0 wt %, or 8.0 wt %, or 9.0 wt %, or 10.0 wt %, or 15.0 wt %, or 20.0 wt % silanol condensation catalyst masterbatch, based on total weight of the composition.

The polymeric composition may include an ultraviolet (UV) absorber or stabilizer. A nonlimiting example of a suitable UV stabilizer is a hindered amine light stabilizer (HALS). A nonlimiting example of a suitable HALS is 1,3,5-Triazine-2,4,6-triamine, N,N-1,2-ethanediylbisN-3-4,6-bisbutyl(1,2,2,6,6-pentamethyl-4-piperidinyl) amino-1,3,5-triazin-2-ylaminopropyl-N,N-dibutyl-N,N-bis(1,2,2,6,6-pentamethyl-4-piperidinyl)-1,5,8,12-tetrakis[4,6-bis(n-butyl-n-1,2,2,6,6-pentamethyl-4-piperidylamino)-1,3,5-triazin-2-yl]-1,5,8,12-tetraazadodecane, which is commercially available as SABO™ STAB UV-119 from SABO S.p.A. of Levate, Italy. In an embodiment, the composition contains from 0 wt %, or 0.001 wt %, or 0.002 wt %, or 0.005 wt %, or 0.006 wt % to 0.007 wt %, or 0.008 wt %, or 0.009 wt %, or 0.01 wt %, or 0.2 wt %, or 0.3 wt %, or 0.4 wt %, or 0.5 wt %, 1.0 wt %, or 2.0 wt %, or 2.5 wt %, or 3.0 wt % UV absorber or stabilizer, based on total weight of the composition.

The composition may include a processing aid. Nonlimiting examples of suitable processing aids include oils, organic acids (such as stearic acid), and metal salts of organic acids (such as zinc stearate). In an embodiment, the composition contains from 0 wt %, or 0.01 wt %, or 0.02 wt %, or 0.05 wt %, or 0.07 wt %, or 0.1 wt %, or 0.2 wt %, or 0.3 wt %, or 0.4 wt % to 0.5 wt %, or 0.6 wt %, or 0.7 wt %, or 0.8 wt %, or 1.0 wt %, or 2.0 wt %, or 2.5 wt %, or 3.0 wt %, or 5.0 wt %, or 10.0 wt %, or 20.0 wt % processing aid, based on total weight of the composition.

The composition may contain from 0 wt % or greater, or 0.001 wt % or greater, or 0.002 wt % or greater, or 0.005 wt % or greater, or 0.006 wt % or greater, or 0.008 wt % or greater, or 0.009 wt % or greater, or 0.01 wt % or greater, or 0.2 wt % or greater, or 0.3 wt % or greater, or 0.4 wt % or greater, or 0.5 wt % or greater, or 1.0 wt % or greater, or 2.0 wt % or greater, or 3.0 wt % or greater, or 4.0 wt % or greater, or 5.0 wt % or greater, or 10.0 wt % or greater, or 15.0 wt % or greater, or 20.0 wt % or greater, or 30 wt % or greater, or 40 wt % or greater, or 50 wt % or greater additive, based on the total weight of the polymeric composition.

### Coated Conductor

The present disclosure also provides a coated conductor. The coated conductor includes a conductor and a coating on the conductor, the coating including the polymeric composition. The polymeric composition is at least partially disposed around the conductor to produce the coated conductor. The conductor may comprise a conductive metal.

The process for producing a coated conductor includes mixing and heating the polymeric composition to at least the melting temperature of the polymeric components in an extruder to form a polymeric melt blend, and then coating the polymeric melt blend onto the conductor. The term “onto” includes direct contact or indirect contact between the polymeric melt blend and the conductor. The polymeric melt blend is in an extrudable state.

The polymeric composition is disposed around on and/or around the conductor to form a coating. The coating may be one or more inner layers such as an insulating layer. The coating may wholly or partially cover or otherwise surround or encase the conductor. The coating may be the sole component surrounding the conductor. Alternatively, the coating may be one layer of a multilayer jacket or sheath encasing the conductor. The coating may directly contact the conductor. The coating may directly contact an insulation layer surrounding the conductor.

### EXAMPLES

### Test Methods

Tensile strength and elongation: Tensile strength and elongation was performed on 2 millimeters (mm) dog bones cut from cured plates. The tensile tensing and elongation testing were performed according to protocol 527-2 by the International Organization for Standards (ISO) using a Zwick 1010 tensile tester. The tensile tester used test T10L and a 100 newton (N) load cell for samples having a tensile strength of 10 megapascals (MPa) or less and test T10 with a 10 kilonewton (KN) load cell for samples having a tensile strength of 10 MPa or greater. The sensor of the tensile tester was set to multisense mode, the test speed was 200 mm per minute and the grip distance was 50 mm Heat ageing: Heat ageing was performed by hanging the samples via metallic clamps form trays inside a Heraus air oven at a temperature of 120° C. for a time period of 10 days in accordance with International Electrotechnical Commission standard 60811-401.

Oil ageing: Oil ageing was performed by placing rectangular shaped samples of dimensions 50 mm×25 mm×2 mm into IRM 902 oil in a pan and heating the oil and samples in a Block oven at a temperature of 100° C. for a time period of 7 days in accordance with International Electrotechnical Commission standard 60811-2-1.

### Materials

The materials used in the examples are provided below.

Terpolymer is an ethylene/vinyl acetate/carbon monoxide (E/VA/CO) copolymer commercially available as ELVALOY™ 741 from The Dow Chemical Company, Midland, Mich.

EVA is an ethylene-vinyl acetate copolymer having a 40 wt % vinyl acetate comonomer content, a density of 0.967 g/cc as measured according to ASTM D792 and a melt index of 3 g/10 min at 190° C./21.6 kg as measured according to ASTM D1238 and commercially available as ELVAX™ 40L-03 from The Dow Chemical Company, Midland, Mich.

AEM is an ethylene-acrylic elastomer having a acrylic comonomer concentration of greater than 40 wt % and commercially available as VAMAC™ 1122 from DuPont, Wilmington, Del.

AP1 is a powder of polymeric particles having a core-shell morphology with the core comprising units derived from butyl acrylate and the shell comprising units derived from methyl methacrylate. The particles as a whole comprise from 93 wt % to 94% of units derived from butyl acrylate, and units derived from 6 wt % to 7 wt % of methyl methacrylate and are commercially available from The Dow Chemical Company, Midland, Mich.

AP2 is a powder of polymeric particles having a core-intermediate layer-shell morphology. The core comprises units derived from butyl acrylate and crosslinked with butanediol di(meth)acrylate and allyl methacrylate. The intermediate layer of AP2 comprises units derived from butyl acrylate, units derived from methyl methacrylate and is crosslinked using allyl methacrylate. The shell of AP2 is comprised of units derived from butyl acrylate, units derived from methyl methacrylate and 1-dodecanethiol. AP2 has an overall composition of 55.8 wt % of units derived from butyl acrylate, 43.2 wt % of units derived from methyl methacrylate, 0.35 wt % units derived from butanediol diacrylate, 0.35 wt % units derived from allyl methacrylateand 0.3 wt % units derived from 1-dodecanethiol and is commercially available from The Dow Chemical Company, Midland, Mich.

HFFR is magnesium hydroxide, an example of which is commercially available under the tradename MAGNIFIN™ H-5MV from the Albemarle Corporation Charlotte, N.C., USA.

Stabilizer is an amine antioxidant having a CAS number of 10081-67-1 and is commercially available as NAUGARD™ 445 from Brenntag, Essen, Germany.

AO is a sterically hindered phenolic antioxidant having the chemical name pentaerythritol tetrakis(3-(3,5-di-tert-butyl-4-hydroxyphenyl)propionate), which is commercially available as IRGANOX™ 1010 from BASF, Ludwigshafen, Germany.

PEG is polyethylene glycol having a weight average molecular weight of from 3,600 g/mol to 4,400 g/mol as measured using gel permeation chromatography and commercially available as CARBOWAX™ PEG 4000 from The Dow Chemical Company, Midland, Mich.

SA is stearic acid having a CAS number of 57-11-4 and commercially available from Sigma Aldrich, St. Louis, Mo.

Silane is an oligmeric siloxane containing vinyl, propyl and ethoxy groups and is commercially available as DYNASYLAN™ 6598 from Evonik, Essen, Germany.

Xlink is propylidynetrimethyl trimethacrylate on silicon dioxide and is commercially available as SARET™ 517 from Sartomer, Exton, Pa.

Pox is di(tert-butylperoxyisopropyl) benzene and is commercially available as PERKADOX™ 14-40 GR from Nouryon, Amsterdam, Netherlands.

### Sample Preparation

The samples were prepared by placing the polymeric components in a Haake Rheomix mixer that had been preheated to 140° C. The samples were mixed for 5 minutes at a speed of 45 revolutions per minute (RPM). Next, half of the total amount of filler was added along with all other additives but the peroxide. Mixing was then continued for 3 minutes at 45 RPM. Next, the final half of the filler was added and the examples were mixed for another 5 minutes at 45 RPM. The examples were then cooled to 130° C. using an internal air-cooling system of the mixer and mixing was slowed to 10 RPM. Once at 130° C., peroxide was added and the mixing speed was increased to 30 RPM for 3 minutes. The examples were then removed from the mixer and allowed to cool under ambient conditions (i.e., 23° C.)

The samples were then placed in the four plate chambers of a LP-S-80/S compression molding unit from Labtech Hydraulic Press with an attached water-cooling unit. The plate chambers had been preheated to 180° C. The samples were pressed at 10 MPa for 10 minutes and then underwent a cooling ramp under pressure of 15° C./minute to 50° C. The samples were then further cooled by placing the plates on a water-cooled table.

### Results

Table 1 provides the composition of inventive examples (IE) IE1-IE4 and comparative examples (CE) CE1-CE3. Table 1 also provides the mechanical testing data for the initial state, oil aged state and heat aged state for IE1-IE4 and CE1-CE3.

TABLE 1

| Test | Material (wt %) | C1 | CE2 | CE3 | IE1 | IE2 | IE3 | IE4 |
|---|---|---|---|---|---|---|---|---|
| | Terpolymer | 11.1 | 14.9 | 8.1 | | | | |
| | EVA | | 3.7 | 10.6 | 18.6 | 18.6 | 13.0 | 7.5 |
| | AEM | 25.9 | | | | | | |
| | AP1 | | 5.6 | 18.6 | 18.6 | 0.0 | 13.8 | 6.0 |
| | AP2 | | 13.0 | 0.0 | 0.0 | 18.6 | 10.4 | 23.8 |
| | TOTAL Polyacrylates | 25.9 | 18.6 | 18.6 | 18.6 | 18.6 | 24.2 | 29.8 |
| | TOTAL Polymer | 37.0 | 37.3 | 37.3 | 37.3 | 37.3 | 37.3 | 37.3 |
| | HFFR | 59.3 | 59.6 | 59.6 | 59.6 | 59.6 | 59.6 | 59.6 |
| | Stabilizer | 0.4 | 0.4 | 0.4 | 0.4 | 0.4 | 0.4 | 0.4 |
| | AO | | 0.1 | 0.1 | 0.1 | 0.1 | 0.1 | 0.1 |
| | PEG | | 0.7 | 0.7 | 0.7 | 0.7 | 0.7 | 0.7 |
| | SA | 0.6 | | | | | | |
| | Silane | 0.7 | 0.7 | 0.7 | 0.7 | 0.7 | 0.7 | 0.7 |
| | Xlink | 0.4 | 0.4 | 0.4 | 0.4 | 0.4 | 0.4 | 0.4 |
| | POx | 1.7 | 0.8 | 0.8 | 0.8 | 0.8 | 0.8 | 0.8 |
| | TOTAL | 100.0 | 100.0 | 100.0 | 100.0 | 100.0 | 100.0 | 100.0 |
| Initial | Tensile Strength (MPa) | 5.3 | 9.8 | 8.1 | 7.8 | 9.5 | 8.5 | 10.5 |
| | Elongation (%) | 209 | 52 | 75 | 85 | 90 | 66 | 34 |
| Oil Aging | Tensile Strength (MPa) | 5.9 | 9.5 | 7.5 | 6.3 | 6.9 | 6.8 | 8.7 |
| | Change in TS (%) | 12 | −3 | −7 | −20 | −27 | −20 | −17 |
| | Elongation (%) | 206 | 62 | 72 | 79 | 109 | 69 | 57 |
| | Change in E (%) | −2 | 19 | −4 | −7 | 22 | 5 | 68 |
| Heat Aging | Tensile Strength (MPa) | 8 | 15 | 10.4 | 9.8 | 11.7 | 11 | 11.7 |
| | Change in TS (%) | 51 | 53 | 28 | 25 | 23 | 29 | 11 |
| | Elongation [%] | 108 | 28 | 50 | 85 | 82 | 60 | 32 |
| | Change in E (%) | −49 | −46 | −33 | 1 | −9 | −9 | −6 |

As can be seen from Table 1, CE1-CE3 fail to have their post heat and oil aging tensile strength and elongation properties remain within ±30% the initial tensile strength and elongation values. CE1-CE3 each incorporate the terpolymer and are able to maintain oil aging properties within the ±30% of the initial tensile strength and elongation values. CE 2 and CE3 each comprise particles of the acrylic phase, but are unable to pass the heat and oil aging tests. IE1-IE4, each comprising the ethylene polymer and the acrylate phase, are able to maintain their post heat and oil aging tensile strength and elongation properties within ±30% the initial tensile strength and elongation values.

1. A resin composition, comprising:
20 wt % to 70 wt % of an ethylene polymer based on a total weight of the resin composition, wherein the ethylene polymer comprises a polar comonomer; and
30 wt % to 80 wt % of an acrylate phase based on the total weight of the resin composition, wherein the acrylate phase comprises units derived from butyl acrylate and units derived from methyl methacrylate.

2. The resin composition of claim 1, wherein the resin composition comprises 50 wt % to 80 wt % of the acrylate phase based on a total weight of the resin composition.

3. The resin composition of claim 1, wherein the resin composition comprises 20 wt % to 50 wt % of the ethylene polymer based on a total weight of the resin composition.

4. The resin composition of claim 1, wherein the ethylene polymer comprises a polar comonomer content of 40 wt % or less based on a total weight of the ethylene polymer.

5. The resin composition of claim 1, wherein the ethylene polymer comprises ethylene vinyl acetate, ethylene methyl acrylate copolymer, ethylene butyl acrylate copolymer, ethylene ethyl acrylate copolymer.

6. The resin composition of claim 1, wherein the acrylate phase comprises a core-shell morphology where a portion of the shell is in contact with and surrounding a portion the core, and further wherein the shell comprises the units derived from methyl methacrylate and the core comprises the units derived from butyl acrylate.

7. The resin composition of claim 6, wherein the core is crosslinked.

8. A polymeric composition, comprising:
20 wt % to 50 wt % of the resin composition of claim 1, based on a total weight of the polymeric composition; and
40 wt % to 75 wt % of a flame-retardant filler based on a total weight of the polymeric composition, wherein the flame-retardant filler comprises at least one of magnesium hydroxide, aluminum trihydrate, calcium carbonate, hydrated calcium silicate and hydrated magnesium.

9. The polymeric composition of claim 8, wherein the ethylene polymer of the resin composition comprises a hydrolyzable silane monomer of the formula: 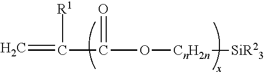
in which R¹ is a hydrogen atom or methyl group; x is 0 or 1; n is an integer from 1 to 4, or 6, or 8, or 10, or 12; and each R² independently is a hydrolyzable organic group such as an alkoxy group having from 1 to 12 carbon atoms (e.g., methoxy, ethoxy, butoxy), an aryloxy group (e.g., phenoxy), an araloxy group (e.g., benzyloxy), an aliphatic acyloxy group having from 1 to 12 carbon atoms (e.g., formyloxy, acetyloxy, propanoyloxy), an amino or substituted amino group (e.g., alkylamino, arylamino), or a lower-alkyl group having 1 to 6 carbon atoms, with the proviso that not more than one of the three R² groups is an alkyl.

10. A coated conductor comprising:
a conductor; and
the polymeric composition of claim 8 disposed at least partially around the conductor.
